(19) United States
(12) Patent Application Publication
(10) Pub. No.: US 2025/0112900 A1
(43) Pub. Date: Apr. 3, 2025

(54) SYSTEMS AND METHODS FOR HIDDEN DATA TRANSFER

(71) Applicant: Acronis International GmbH, Schaffhausen (CH)

(72) Inventors: Serg Bell, Costa del Sol (SG); Stanislav Protasov, Singapore (SG)

(21) Appl. No.: 18/477,040

(22) Filed: Sep. 28, 2023

(51) Int. Cl. H04L 9/40; H04L 9/06

(52) U.S. Cl. CPC H04L 63/0428; H04L 9/0618

(57) ABSTRACT

Systems and methods for hiding data inside data communications other than a primary message (e.g. primary data). An encoder coupled to a message generator can include hidden data not inside the primary message, but inside secondary data, such as additional technical information or metadata. An injector can inject hidden data in secondary data received as part of a data transmission.

### TECHNICAL FIELD

Embodiments relate generally to data communication. More particularly, embodiments relate to hiding data in data communications.

### BACKGROUND

Communication between computing devices includes the transfer and reception of data over a communication channel (e.g. point-to-point or point-to-multipoint). Such computing devices often exchange sensitive information over the communication channel, for example, using symmetric encryption or asymmetric encryption.

Sometimes, computing devices need to transfer a very small amount of sensitive information without resorting to full symmetric or asymmetric encryption, or when it is not possible to use such encryption, for example, due to resource, timing, or other constraints.

Therefore, there is a need for improved transfer of small amounts of sensitive information.

### SUMMARY

Embodiments described or otherwise contemplated herein substantially meet the aforementioned needs of the industry. Embodiments described herein include systems and methods for hiding data inside data communications other than a primary message (e.g. primary data). As used herein, “hidden data” or “encoding” are used interchangeably to mean data placed in the secondary data with the intent to hide such data. Embodiments can utilize an encoder coupled to a message generator to include hidden data not inside the primary message, but inside secondary data, such as additional technical information or metadata. Embodiments further include an injector to inject hidden data in secondary data received as part of a data transmission or data stream, the data transmission or data stream also including a primary message.

In a feature and advantage of embodiments, data is not encoded directly inside a main stream. Rather, embodiments use auxiliary data, such as sections of metadata or control data, to encode hidden data.

In an embodiment, a system for hiding data comprises an encoder engine configured to: obtain a payload created by a message generation subsystem, determine metadata associated with the payload, and generate modified metadata with an encoding for the payload; and a transmitter engine configured to transmit the payload and the modified metadata

In one aspect, a system further comprises a decoder engine configured to: receive the transmitted payload and the modified metadata, parse the modified metadata, and decode the modified metadata.

In an embodiment, a system for hiding data comprises an injector including: a receiver engine configured to receive a package on a communication interface; an in-stream injector engine configured to: determine metadata associated with the package, generate modified metadata with an encoding for the package, and inject the modified metadata in the package; and a forwarder engine configured to forward the package including the modified metadata on the communication interface.

In one aspect, a system further comprises a listener including: an interceptor engine configured to intercept the transmitted package including the modified metadata; and a decoder engine configured to: parse the package to determine the modified metadata, and decode the modified metadata.

In an embodiment, a method of hiding data comprises receiving a message, the message including a primary data portion; generating a secondary data portion to include an encoding, the secondary data portion including metadata associated with the primary data portion; incorporating the secondary data portion in the message; and transmitting the message.

The above summary is not intended to describe each illustrated embodiment or every implementation of the subject matter hereof The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a block diagram of a system for hiding data using an encoder, according to an embodiment.

FIGS. 2A-2B are block diagrams of TCP segment headers, according to an embodiment.

FIGS. 3A-3B are a flowchart of a method for hiding data using an encoder, according to an embodiment.

FIG. 4 is a block diagram of a system for hiding data using an injector, according to an embodiment.

FIG. 5 is a block diagram of an injector, according to an embodiment.

FIG. 6 is a block diagram of a listener, according to an embodiment.

FIGS. 7A-7B are a flowchart of a method for hiding data using an injector, according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

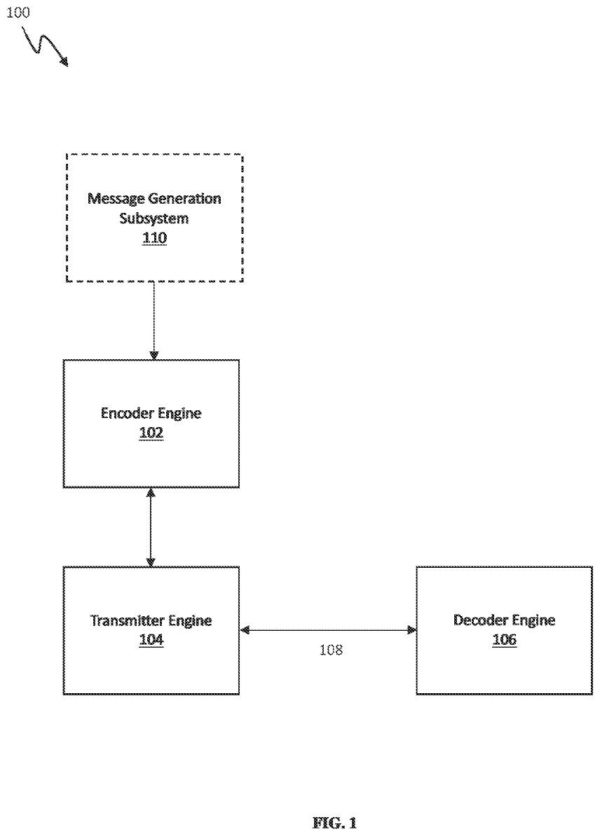

Referring to FIG. 1, a block diagram of a system 100 for hiding data by encoding is depicted, according to an embodiment. System 100 generally comprises an encoder engine 102, a transmitter engine 104, a decoder engine 106, and a communication channel 108. As illustrated, system 100 can further optionally comprise a message generation subsystem 110.

Embodiments described herein includes various engines, each of which is constructed, programmed, configured, or otherwise adapted, to autonomously carry out a function or set of functions. The term engine as used herein is defined as a real-world device, component, or arrangement of components implemented using hardware, such as by an application specific integrated circuit (ASIC) or field-programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

Encoder engine 102 is configured to obtain a message payload. For example, encoder engine 102 can obtain a payload from message generation subsystem 110. In an embodiment, message generation subsystem 110 is configured to generate a communication message as a payload including at least primary data. In an embodiment, primary data can include a main data sequence particular to the specific message generation subsystem 110. In an embodiment, secondary data can be a data sequence associated with the main data sequence.

In an embodiment, message generation subsystem 110 can be an Internet application. For example, an internet application operating on an IP network can generate a data stream. A web browser or server application can be coupled to a TCP/IP stack of an operating system of its corresponding networked computing device.

Using TCP, data is accepted from the data stream, divided into chunks, and a TCP header is added, thereby creating a TCP segment. The TCP segment is then encapsulated into an Internet Protocol (IP) datagram and exchanged over the network (e.g. TCP/IP). A TCP segment includes a data section (e.g. primary data) and a segment header (e.g. secondary data). Data can be hidden in the segment header.

Though TCP and TCP/IP are described here and used as example embodiments herein, other data transfer protocols can likewise be used, including User Datagram Protocol (UDP), HTTP, HTTPS, IPv6, Wi-Fi, optical data transmission, audio stream, ZigBee, Bluetooth, radio transmission, or using any other modulation over any other data carrier. Moreover, embodiments described herein can be utilized at any communication layer, for example, Open Systems Interconnection (OSI) model physical layer, data link layer, network layer, transport layer, session layer, presentation layer, or application layer. In embodiments, any suitable stream in which communications are occurring from a client to a server (and back) can be utilized.

In another example, message generation subsystem 110 can be an artificial intelligence (AI) system. In an embodiment, an AI system can include a large language model (LLM) as a trained deep-learning model that understands and generates text in a human-like fashion. In one specific example, the message generation subsystem 110 as an LLM is an AI chatbot that uses natural language processing to create humanlike conversational dialogue. A user can request of the AI system, “please explain this picture in words.” In response, the AI system can generate a sequence of words as primary data with corresponding internal representations as secondary data. Data can be hidden in the internal representations.

In another example, message generation subsystem 110 can be a video generation engine. For example, a video generation engine can include a visual implementation of video data to be viewed on a computing device as primary data. In an embodiment, the video data can have associated representation settings (e.g. how the video data is to be viewed on a particular computing device) as secondary data. Data can be hidden in these representation settings, or other data associated with the primary video transmission. Similarly, message generation subsystem 110 can be an audio generation engine.

In another example, message generation subsystem 110 can include a blockchain-specific protocol, which can include secondary data such as a hash. In an embodiment, message generation subsystem 110 can include multiple blockchain systems and can implement Inter-Blockchain Communication (IBC) protocol.

In other embodiments, message generation subsystem 100 can be an Electronic Programming Guide (EPG) from a cable or satellite source. An EPG is a digital menu system that provides a user with a list of television programs and other video content. Accordingly, the list of programs can be primary data, and the corresponding channel, time, genre, and other associated criteria associated with the list of programs can be secondary data in which data can be hidden.

In embodiments, message generation subsystem 110 can be any generator of a stream or sequence of primary data. In embodiments, by utilizing secondary data associated with the primary data, the hidden data can be better hidden than in the primary data, even appearing to be random to a malicious listener attempting to determine the hidden data.

In an embodiment, encoder engine 102 and message generation subsystem 110 can be integrated into a single component but are depicted in FIG. 1 for ease of discussion. For example, encoder engine 102 can itself be configured to generate a message including primary data and secondary data, and encode the data, as will be described.

Encoder engine 102 is further configured to determine secondary data associated with the message payload. For example, encoder engine 102 is configured to determine metadata associated with a primary message of the message payload. In an example, encoder engine 102 can determine the protocol by which the payload will be transmitted and determine associated metadata fields. In another example, certain metadata may already be populated for the message payload.

In the aforementioned example of transfer using TCP/IP, encoder engine 102 can determine a segment header associated with a particular TCP segment. Encoder engine 102 can thus determine the relevant secondary data and location in which an encoding can be placed. More particularly, encoder engine 102 can be configured to implement an encoding algorithm. The encoding algorithm can include both the relative location of the encoding and how to encode the encoding.

In an embodiment, encoder engine 102 is further configured to modify the encoding algorithm to a modified encoding algorithm. In an embodiment, encoder engine 102 can communicate the modified encoding algorithm to decoder engine 106. For example, encoder engine 102 can utilize transmitter engine 104 to transmit the modified encoding algorithm, such as in communications that hide data as described herein. In another embodiment, encoder engine 102 can communicate the modified encoding algorithm along another communication channel other than as in communications that hide data as described herein. Subsequent communications between encoder engine 102 and decoder engine 106 can utilize the modified encoding algorithm. Or, in embodiments, communications from encoder engine 102 to decoder engine 106 can indicate which of a plurality of modified encoding algorithms are being used. Embodiments thereby achieve a polymorphic system of encoding. In other words, the way data is included/encoded can be changed.

Encoder engine 102 is further configured to modify secondary data or otherwise cause modified secondary data to be generated. In an example, encoder engine 102 is configured to modify the secondary data with hidden data in the TCP segment of the primary message. For example, every TCP segment includes its own sequence number and checksum. In this example, for TCP sequence number: 0, encoder engine 102 is configured to encode a TCP segment of the original primary message in the TCP segment data section, and retain the original checksum of the TCP segment. An encoding can be selectively inserted into one or more fields of the secondary data so that the data appears to be unmodified.

In another example, encoder engine 102 is configured to modify the secondary data with hidden data in one or more subsequent TCP segments of the primary message. More particularly, a package can include an original plaintext and the original metadata in a first segment of a plurality of segments and another plaintext (e.g. the original plaintext or a different second plaintext) and modified metadata in a second segment of the plurality of segments. In TCP sequence number: 0, encoder engine 102 can forward the original primary message in the TCP segment data section and the original metadata in the TCP segment header (e.g. checksum metadata). In TCP sequence number: 1, encoder engine 102 can generate a TCP segment with the original primary message in the TCP segment data section, but an encoding or hidden data in the TCP segment header (e.g. checksum metadata).

In another embodiment, in TCP sequence number: 1, encoder engine 102 is configured to modify the metadata by generating an encoding plaintext, wherein the modified metadata is generated by the payload packaging of the encoding plaintext. In an example, the payload packaging is done by one or more components of the TCP/IP stack. More particularly, encoder engine 102 knows the payload packaging algorithm and can generate encoding plaintext such that when fed to the payload packaging algorithm, desired metadata corresponding to the encoding is generated. Accordingly, in an embodiment, encoder engine 102 can directly modify the metadata with an encoding. In another embodiment, encoder engine 102 can indirectly modify the metadata by generating an encoding message such that payload packaging generates the desired metadata including the encoding. In embodiments, small or minor modifications to the encoding plaintext can thereby generate the desired encoding in the metadata. In other words, transmitted secret data is not incorporated in a primary stream or in primary data. This modification of external data of a transmitted message reduces the likelihood of interception or detection.

In an embodiment, encoder engine 102 can utilize a control sum to indicate that an encoding was sent, to ensure the correctness of the encoding, and/or to indicate the end of an encoding transmission. For example, a control sum can be included with the encoding that can be subsequently evaluated by decoder engine 106 to evaluate the encoding. Such values can include a CRC value, a control sum, a static or dynamic signature, a predefined timestamp value, and so on.

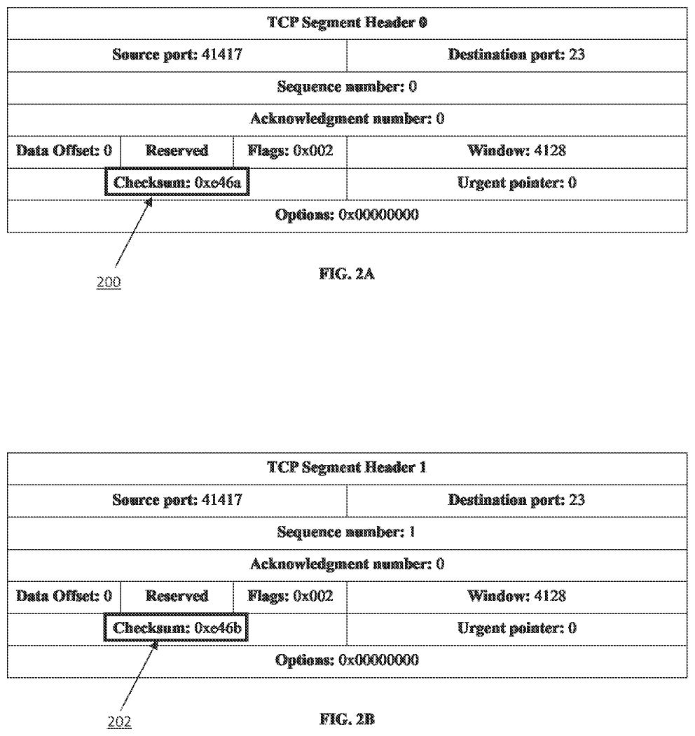

Referring to FIGS. 2A-2B, block diagrams of TCP segment headers are depicted, according to an embodiment. For example, FIG. 2A depicts TCP sequence number: 0 in which an original checksum 200: 0xe46a corresponding to an original data section is transmitted. FIG. 2B depicts TCP sequence number: 2 in which the TCP segment header has been modified. In particular, an encoding of hidden data is included in checksum 202: 0xe46b. Accordingly, data included in the checksum is correct from the point of view from the IP protocol (or other protocol). More particularly, for any kind of checksum or redundancy check, the checksum remains correct for the particular data section, and other data sections are utilized to transfer hidden data.

In another example, a plurality of TCP segments can similarly be modified with an encoding. For example, encoder engine 102 is configured to modify the original secondary data with hidden data corresponding to a single encoding. In TCP sequence number: 0, encoder engine 102 can forward the original primary message in the TCP segment data section and the original metadata in the TCP segment header. In TCP sequence number: 1, encoder engine 102 can generate a TCP segment with a modified primary message in the TCP segment data section, and a first portion of an encoding in the TCP segment header. In TCP sequence number: 2, encoder engine 102 can generate a TCP segment with a modified primary message in the TCP segment data section, and a second portion of the encoding in the TCP segment header. Accordingly, a plurality of TCP segments can be utilized to hide a single encoding.

In an embodiment, encoder engine 102 is configured to modify only a portion of the secondary data. For example, where the secondary data is defined by a set of bits, the encoding is only a subset of the set of bits. In the TCP segment example, encoder engine 102 can modify a portion of the secondary data such that the content of the data is not violated. In an embodiment, encoder engine 102 is configured to modify one or more portions of the secondary data so that the original checksum is not modified, but rather, another field in the secondary data is modified. In an example, one or more other fields, such as data offset, flags, window, urgent pointer, or options fields can be modified and the original checksum is retained.

In another embodiment, encoder engine 102 is configured to modify varying portions of the secondary data. In the TCP segment example, the encodings can be hidden throughout any of the segment header fields. In one example, encoder engine 102 can encode a first encoding in bits 128-136 of the checksum field for a first TCP segment. Encoder engine 102 can encode a second encoding in bits 160-168 for a second TCP segment, and so on. As described above, while TCP is utilized as an example, any data carrier can be utilized.

In an embodiment, encoder engine 102 is configured to modify secondary data across multiple fields such that fields are joined together upon decoding. In an embodiment, encoder engine 102 is configured to encode the message in a redundant way, such as by using an error correction code (ECC). Redundancies therefore allow the receiver (e.g. decoder engine 106) to detect errors in the hidden data, but to also correct a limited number of errors.

Transmitter engine 104 is configured to package and deliver various payloads and metadata over communication channel 108. Accordingly, transmitter engine 104 is configured to receive the payload and/or metadata from encoder engine 102, package the payload and metadata, and interface to communication channel 108. The packaging can thus include modified and unmodified primary and/or secondary data from message generation subsystem 110, as encoded by encoder engine 102 as described above. In an embodiment, transmitter engine 104 can receive both primary data and secondary data from encoder engine 102. In another embodiment, transmitter engine 104 can receive only primary data from encoder engine 102 and utilize a packaging algorithm for the specific communication protocol to generate the secondary data.

Thus, in embodiments, encoder engine 102 and transmitter engine 104 can be operably coupled to generate and package the encodings described herein. In one example, encoder engine 102 and transmitter engine 104 can implement an iterative process. More particularly, encoder engine 102 can request a package of transmitter engine 104 for a respective payload, then modify the secondary data of the package, and communicate the modified package to transmitter engine 104. In other embodiments, encoder engine 102 can simply pass a respective payload to transmitter engine 104 such that transmitter engine 104 creates the encoding (e.g. in the encoding plaintext example).

Communication channel 108 can be wired or wireless and be implemented according to any suitable protocol, such as USB, BLUETOOTH, Internet Protocol (IP), Wi-Fi, or any other appropriate format. In the aforementioned TCP segment example, communication channel 108 can comprise an IP network such that message generation subsystem (via encoder engine 102 and transmitter engine 104) along with decoder engine 106 are applications running on hosts communicating via the IP network. In an embodiment, transmitter engine 104 can therefore implement connection establishment that establishes a connection, data transfer, and connection termination that closes the connection and releases all allocated resources. Transmitter engine 104 can therefore include components of the TCP/IP stack.

Transmitter engine 104 is configured to transmit the payload and metadata. In an embodiment, transmitter engine 104 can transmit a package of the payload and metadata in a plurality of segments. In the TCP segment example, the package can be a TCP/IP packet or TCP/IP packet fragment. In such embodiments, transmitter engine 104 can include a payload packaging algorithm for TCP/IP. Transmitter engine 104 can transmit a package according to point-to-point or point-to-multipoint communications. As illustrated in FIG. 1, transmitter engine 104 can transmit the payload to decoder engine 106.

In an embodiment, transmitter engine 104 (in coordination with encoder engine 102) is configured for IP fragmentation such that encodings can be transmitted using metadata from multiple fragments. IP fragmentation is an Internet Protocol (IP) process that breaks packets into smaller pieces (fragments), so that the resulting pieces can pass through a link with a smaller maximum transmission unit than the original packet size. The fragments are reassembled by the receiving host.

For example, encoder engine 102 can generate plaintext or encoding text, which can be large. Put another way, encoder engine 102 can generate a TCP preload that contains an original message. The TCP preload can be reflected inside a TCP package in a plurality of fragments. In particular, transmitter engine 104 is configured, using the TCP/IP stack, to cut the TCP preload into segments. For each segment there will be TCP header/IP header/segment number etc. and control sum (e.g. 16-bit). Accordingly, a ciphering mechanism utilizes the 16 bits of the control sum to store hidden information. More particularly, encoder engine 102 can make modifications of the TCP preload or into the payload body or to affect the process of how the message is split on the packages (for example window size or message segment size. Thus, for each segment, there is separate metadata where hidden data can be stored. When encoder engine 102 modifies encoding text (for example adding a space) it will lead to a different control sum, because the TCP segment will change and thus the control sum will change. Modification can therefore code certain bits in the control sum.

In an embodiment, transmitter engine 104 is further configured to receive an acknowledgement or confirmation of successful receipt and decoding by the intended recipient (e.g. decoder engine 106 in FIG. 1). Transmitter engine 104 can further relay such confirmation to encoder engine 102.

Decoder engine 106 is configured to receive the transmitted package including the modified secondary data (e.g. metadata) over communication channel 108. In an embodiment, decoder engine 106 comprises a TCP receiver to receive and reassemble the sequence of octets originally transmitted.

Decoder engine 106 is further configured to parse the package to determine the modified secondary data (e.g. modified metadata). Once the receiver portion of decoder engine 106 has received and reassembled the secondary data, the relevant secondary data can be identified by parsing the data. For example, a TCP segment can be parsed into the header and payload data, and further into individual fields of the header.

Decoder engine 106 is further configured to decode the modified secondary data. In an embodiment, once the secondary data has been identified, decoder engine 106 is configured to decode the modified metadata by applying the modified metadata against a plurality of predetermined patterns. For example, decoder engine 106 can be pre-configured to evaluate secondary data against patterns known to decoder engine 106 and encoder engine 102. More particularly, decoder engine 106 can be configured to implement a decoding algorithm. The decoding algorithm can include both the relative location of the encoding and how to decode the encoding.

In an embodiment, decoder engine 106 is configured to detect errors in the hidden data once decoded, for example, using a redundant data transmission of the hidden data. In an embodiment, decoder engine 106 is further configured to correct errors using an interpretation of the hidden data (e.g. using ECC).

In an embodiment, decoder engine 106 can be separate from the main TCP stack. Accordingly, the encoding can be inside or outside of TCP. In an embodiment, decoder engine 106 can read data indirectly, such as during the preparation of TCP packages and/or fragmentation, or after the TCP packet is prepared.

In an embodiment, decoder engine 106 is further configured to optionally generate a confirmation message to indicate that the encoding has been successfully decoded and transmit the confirmation message for receipt by encoder engine 102. For example, decoder engine 106 can transmit the confirmation message by at least one of unicast or multicast communication over communication channel 108.

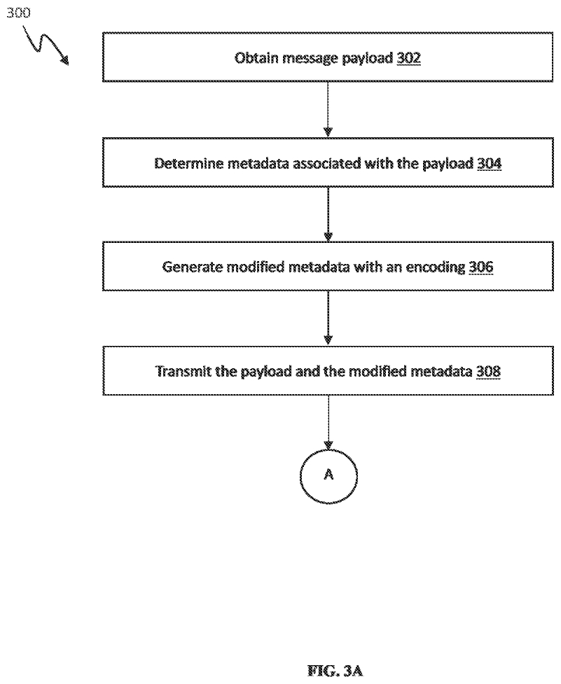

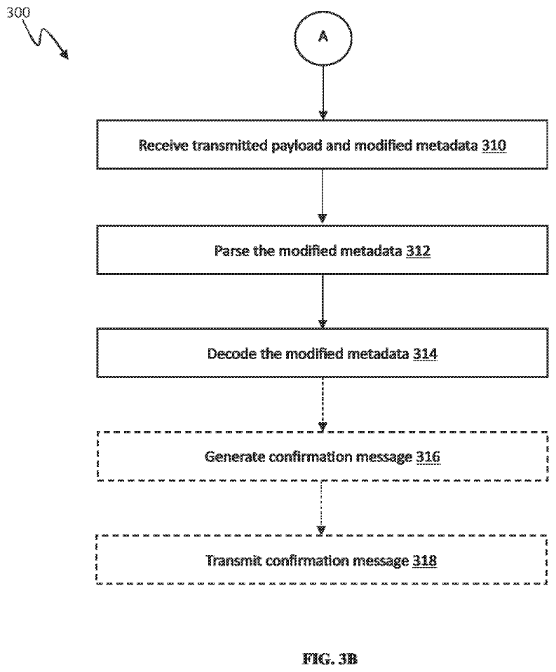

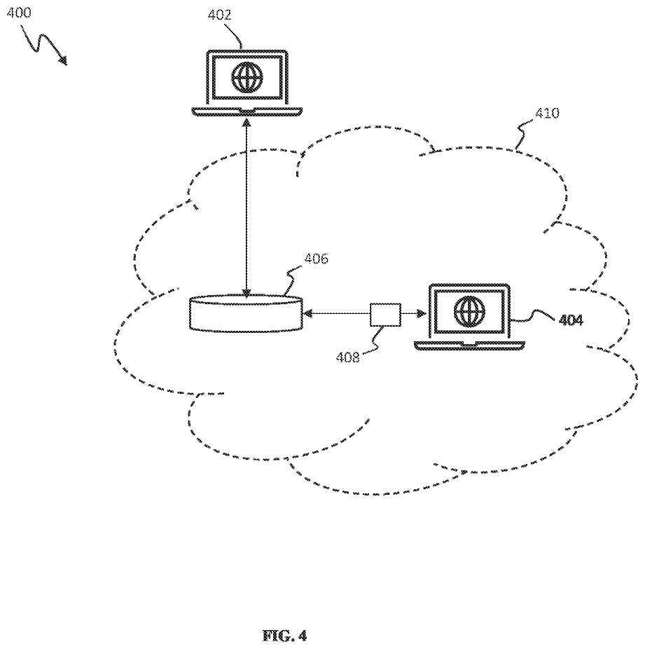

Referring to FIG. 3A, a flowchart of a method 300 for hiding data by encoding is depicted, according to an embodiment. In an embodiment, method 300 can be implemented by system 100. More particularly, the operations illustrated in FIG. 3A can be implemented by encoder engine 102, transmitter engine 104, and message generation subsystem 110.

Method 300 generally comprises, at 302, obtaining a message payload. For example, with reference to FIG. 1, encoder engine 102 can receive a message payload generated by message generation subsystem 110.

At 304, method 300 further comprises determining metadata associated with the message payload. For example, encoder engine 102 can determine secondary data associated with primary data of the payload. Determining secondary data can include determining secondary data fields and/or determining populated secondary data that is associated with primary data.

At 306, method 300 further comprises generating modified metadata with an encoding. For example, encoder engine 102 can generate modified metadata for inclusion in a package for the payload. In an embodiment, modified metadata can be included in any of a plurality of segments in which the payload is transmitted.

At 308, method 300 further comprises transmitting the payload and the modified metadata. For example, transmitter engine 104 can package the payload including modified metadata for transmission over communications channel 108.

Referring further to FIG. 3B, method 300 is further depicted. In particular, the operations illustrated in FIG. 3B can be implemented by decoder engine 106.

At 310, method 300 further comprises receiving the transmitted package, which includes the modified metadata. For example, decoder engine 106 can receive the transmitted package over communications channel 108. Decoder engine can receive and reassemble the payload and metadata.

At 312, method 300 further comprises parsing the reassembled metadata to determine the modified metadata. For example, decoder engine 106 can identify the metadata by parsing appropriate metadata fields. In an embodiment, method 300 can optionally include parsing the payload (though not depicted in FIG. 3B).

At 314, method 300 further comprises decoding the modified metadata. For example, decoder engine 106 can apply a decoding algorithm to determine the relative location of the encoding and the encoding itself.

Optionally, at 316, method 300 further comprises generating a confirmation message. For example, decoder engine 106 can generate a confirmation message to indicate that the encoding has been successfully decoded. In embodiments, the confirmation message can be transmitted similarly to the encoding, such as the same format and encoding process whereby decoder engine 106 itself includes encoding capabilities similar to encoder engine 102 (and likewise, encoder engine 102 itself includes decoding capability similar to decoder engine 106). In other embodiments, the confirmation message can be transmitted according to a different protocol or message format than the encoding.

Optionally, at 318, method 300 further comprises transmitting the confirmation message. For example, decoder engine 106 can transmit the confirmation message across communications channel 108 for receipt by encoder engine 102.

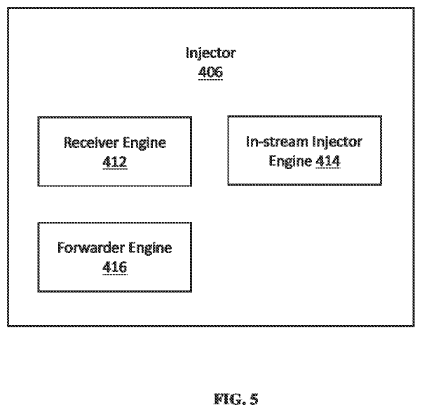

Referring to FIG. 4, a block diagram of a system 400 for hiding data by injecting is depicted, according to an embodiment. System 400 generally depicts a network topology in which data can be hidden using injection at one or more network interface points. More particularly, system 400 can inject hidden data along a network path at a first point at which the injector is installed. System 400 can further receive the stream at a second point in the network by listening and subsequently extract the hidden data.

System 400 generally includes a first networked device 402 operably coupled to a second networked device 404. System 400 further comprises an injector 406 and a listener 408. As illustrated in FIG. 4, components of system 100 can be included in a network 410 including one or more communications paths. Though first networked device 402 is depicted as outside of network 410 for ease of illustration, any of system components first networked device 402, second networked device 404, injector 406, and listener 408 can be positioned relatively inside or outside various networks along the communication paths.

First networked device 402 and second networked device 404 can comprise computing devices configured to communicate over network 410. In an embodiment, first networked device 402 and second networked device 404 can be a desktop computer, a laptop computer, tablet, mobile computing device, server, workstation, or Internet-of-things (IoT) device. Accordingly, first networked device 402 and second networked device 404 can implement one or more communication protocols over network 410. The communications using the one or more communication protocols can be utilized to hide data. In contrast to the embodiments described with respect to FIG. 1, first networked device 402 does not inject an encoding. Rather, injector 406 injects an encoding.

Injector 406 is configured to receive a package on a communication interface and inject an encoding. In an embodiment, injector 406 is embedded on a networked device, such as a dedicated router or switch. Accordingly, injector 406 can be somewhere along the network rout of communications between the first networked device 402 and the second networked device 404. Referring also to FIG. 5, a block diagram of injector 406 is depicted, according to an embodiment. Injector 406 generally comprises a receiver engine 412, an in-stream injector engine 414, and a forwarder engine 416.

In an embodiment, receiver engine 412 is configured to receive a package on a communication interface. For example, for an injector 406 embedded in a network device along the communication path of the package, receiver engine 412 can receive the package along the communication path, such as by a router at a network hop.

In-stream injector engine 414 is configured to determine metadata associated with the package and inject an encoding in the metadata by generating modified metadata and inserting the modified metadata in the package. In an embodiment, in-stream injector engine 414 generates the modified metadata to include the encoding without modifying a data section (e.g. plaintext, payload, or other primary data) of the package.

In an example, a 16-bit checksum field is used for error-checking of the TCP header, the payload and an IP pseudo-header. The pseudo-header includes the source IP address, the destination IP address, the protocol number for the TCP protocol (6) and the length of the TCP headers and payload (in bytes).

Assume a MICROSOFT web site that uses a lot of IP addresses. Each destination IP address can be modified by injection (for example, replaced to other IP address from the same group but not from the original package). Such modification doesn't change the text of the payload itself but the control sum or destination IP address can be modified. Embodiments of injecting thereby provide a solution to modify metadata without modification of the plain text message, and modify the data and encode info to packages. In an embodiment, a decoder can read injected info on the way back to MICROSOFT, for example at another segment of the network route.

Forwarder engine 416 is configured to forward the package including the modified metadata along the communication interface. Accordingly, the package can move along a communication path with the hidden data such that the package appears to any observers to be unchanged (e.g. by small changes to non-primary data). In an embodiment, forwarder engine 416 can forward the package along the path determined by the networking component in which injector 406 is integrated (such as a switch or router). In an embodiment, forwarder engine 416 can forward the package along a path different from the original path. In an embodiment, forwarder engine 416 can forward the package along multiple paths.

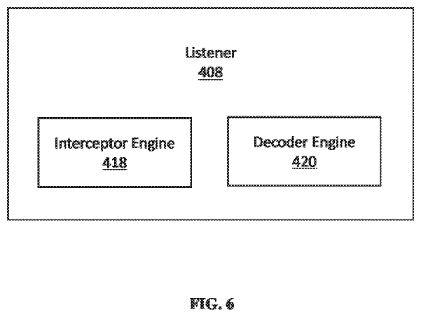

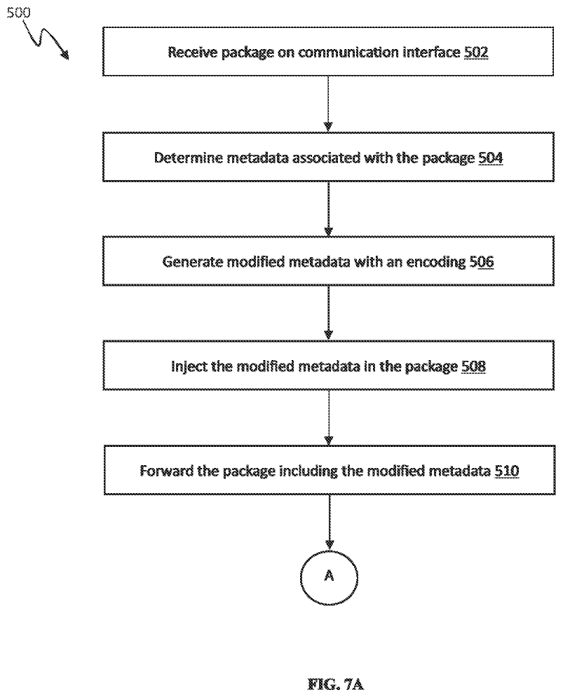

Listener 408 is configured to receive or intercept a package including modified metadata and decode the modified metadata. Accordingly, as illustrated in FIG. 4, listener 408 is positioned along a communication path of network 410 between injector 406 and second networked device 404. Referring also to FIG. 6, a block diagram of listener 408 is depicted, according to an embodiment. Listener 408 generally comprises an interceptor engine 418 and a decoder engine 420.

Interceptor engine 418 is configured to intercept the transmitted package including the modified metadata. Decoder engine 420 is configured to parse the payload to determine the modified metadata and decode the modified metadata. For example, in the TCP/IP example of MICROSOFT websites, decoder engine 420 can identify the modified control sum or destination IP address and apply one or more decoding algorithms to interpret the modified metadata.

In an embodiment, decoder engine 420 can be further configured to modify the transmitted package. For example, decoder engine 420 can effectively remove the transmitted package from the network route such that the transmitted package (or portions of the transmitted package) never reaches second networked device 404. In an embodiment, decoder engine 420 can modify the transmitted package back to a form prior to injector 406's injection of the encoding. For example, decoder engine 420 can delete the encoding and change a timestamp back to its previous timestamp before the encoding. Accordingly, system 400 utilizes the flow of data from first networked device 402 to second networked device 404 to hide and communicate data without knowledge of first networked device 402 or second networked device 404.

Though depicted as separate components for ease of illustration in FIG. 4, listener 408 can be incorporated into second networked device 404, in embodiments. In other embodiments, a system can include multiple injectors. For example, a system can include a second injector having a second receiver engine configured to receive the already modified package on the communication interface, a second in-stream injector engine configured to determine the modified metadata associated with the package, further modify the modified metadata with a second encoding to generate second modified metadata, and inject the second modified metadata in the package, along with a second forwarder engine configured to forward the package including the second modified metadata on the communication interface. In this way, the package can be slowly changed over the communication path to even further evade detection.

Similarly, a system can include multiple listeners. For example, in an embodiment with multiple injectors, a first listener can be positioned to listen to the modifications made by a first injector, and a second listener can be positioned to listen to the modifications made by a second injector, and so on. In this way, the differences between decoded messages by the first listener and the second listener can additionally relay hidden data.

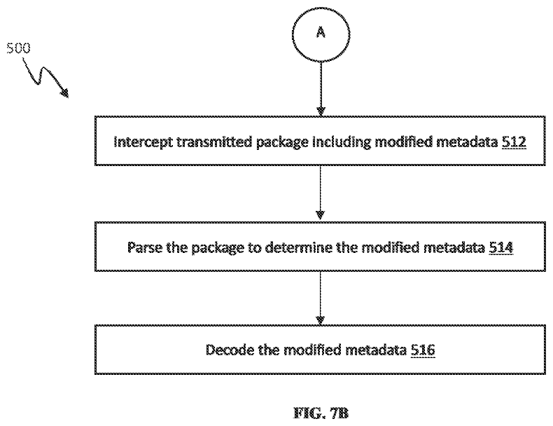

Referring to FIGS. 7A-7B, a flowchart of a method 500 for hiding data by injecting is depicted, according to an embodiment. In an embodiment, method 500 can be implemented by system 300. More particularly, the operations illustrated in FIG. 7A can be implemented by injector 406.

Method 500 generally comprises, at 502, receiving a package on a communication interface. For example, receiver engine 412 can receive a package along a communication path of network 410.

At 504, method 500 further comprises determining metadata associated with the package. For example, in-stream injector engine 414 can determine metadata associated with the package received at 502.

At 506, method 500 further comprises generating modified metadata with an encoding. For example, in-stream injector engine 414 can generate modified metadata to include an encoding for the package.

At 508, method 500 further comprises injecting the modified metadata in the package. For example, in-stream injector engine 414 can inject the modified metadata in the package.

At 510, method 500 further comprises forwarding the package including the modified metadata. For example, forwarder engine 416 can forward the package including the modified metadata along a communication path.

Referring further to FIG. 7B, method 500 is further depicted. In particular, the operations illustrated in FIG. 7B can be implemented by listener 408.

At 512, method 500 further comprises intercepting the transmitted package including the modified metadata. For example, interceptor engine 418 can intercept the transmitted package including the modified metadata.

At 514, method 500 further comprises parsing the package to determine the modified metadata. For example, decoder engine 420 can parse the package to determine the modified metadata.

At 516, method 500 further comprises decoding the modified metadata. For example, decoder engine 420 can decode the modified metadata.

1. A system for hiding data, the system comprising:
an encoder engine configured to:
obtain a payload created by a message generation subsystem,
determine metadata associated with the payload, and
generate modified metadata with an encoding for the payload; and
a transmitter engine configured to transmit the payload and the modified metadata.

2. The system of claim 1, wherein the encoder engine is configured to generate modified metadata by inserting the encoding into the original metadata.

3. The system of claim 1, wherein the encoder engine is configured to generate modified metadata by generating an encoding plaintext, wherein the modified metadata is generated by payload packaging of the encoding plaintext.

4. The system of claim 1, wherein the modified metadata includes a set of bits, and wherein the encoding is only a subset of the set of bits.

5. The system of claim 1, wherein the transmitter engine is configured to transmit the payload and the modified metadata in a package including a plurality of segments.

6. The system of claim 5, wherein the package includes an original plaintext and original metadata in a first segment of the plurality of segments and an encoding plaintext and the modified metadata in a second segment of the plurality of segments, wherein the first segment of the plurality of segments is any segment in the plurality of segments.

7. The system of claim 5, wherein the package includes an original plaintext and the modified metadata in a first segment of the plurality of segments.

8. The system of claim 1, wherein the package includes a TCP/IP packet or TCP/IP packet fragment.

9. The system for hiding data of claim 1, further comprising:
a decoder engine configured to:
receive the transmitted payload and the modified metadata,
parse the modified metadata, and
decode the modified metadata.

10. The system of claim 9, wherein the encoder engine is further configured to generate the modified metadata to include a control value associated with the modified metadata, and wherein the decoder engine is further configured to evaluate the control value in decoding the modified metadata.

11. The system of claim 9, wherein the decoder engine is further configured to:
generate a confirmation message; and
transmit the confirmation message for receipt by the encoder engine.

12. The system of claim 9, wherein the modified metadata is generated using an encoding algorithm and the encoder is further configured to modify the encoding algorithm to a modified encoding algorithm, and wherein the transmitter engine is further configured to transmit the modified encoding algorithm to the decoder engine.

13. A system for hiding data, the system comprising:
an injector including:
a receiver engine configured to receive a package on a communication interface;
an in-stream injector engine configured to:
determine metadata associated with the package,
generate modified metadata with an encoding for the package, and
inject the modified metadata in the package; and
a forwarder engine configured to forward the package including the modified metadata on the communication interface.

14. The system of claim 13, wherein the injector is embedded in a device along a network route of the payload.

15. The system of claim 13, wherein the in-stream injector engine generates the modified metadata with the encoding without modifying a data section of the package.

16. The system of claim 13, further comprising:
a second injector including:
a second receiver engine configured to receive the package including the modified metadata on the communication interface;
a second in-stream injector engine configured to:
determine the modified metadata associated with the package, further modify the modified metadata with a second encoding to generate second modified metadata, and
inject the second modified metadata in the package; and
a second forwarder engine configured to forward the package including the second modified metadata on the communication interface.

17. The system of claim 13, further comprising:
a listener including:
an interceptor engine configured to intercept the transmitted package including the modified metadata; and
a decoder engine configured to:
parse the package to determine the modified metadata, and
decode the modified metadata.

18. The system of claim 17, wherein the listener is embedded in a device along a network route of the package.

19. The system of claim 17, wherein the decoder engine is further configured to modify the package to further modify the modified metadata to remove the encoding or a portion of the encoding.

20. A method of hiding data, the method comprising:
receiving a message, the message including a primary data portion;
generating a secondary data portion to include an encoding, the secondary data portion including metadata associated with the primary data portion;
incorporating the secondary data portion in the message; and
transmitting the message.
